(19) United States
(12) Patent Application Publication
(10) Pub. No.: US 2006/0221939 A1
(43) Pub. Date: Oct. 5, 2006

(54) System and method for simultaneous voice and data call over wireless infrastructure

(76) Inventors: Eric C. Rosen, Solana Beach, CA (US); Stephen A. Sprigg, Poway, CA (US)

Correspondence Address: QUALCOMM INCORPORATED, 5775 MOREHOUSE DR., SAN DIEGO, CA, 92121, US

(21) Appl. No.: 11/096,869

(22) Filed: Mar. 31, 2005

(51) Int. Cl. H04Q 7/00; H04L 12/66

(52) U.S. Cl. 370/352; 370/328; 370/493

(57) ABSTRACT

A system and method for enabling simultaneous voice and data communication over a communication channel having a single pair of allocated Walsh codes in a wireless telecommunication network. A converter server intercepts voice data coming from and going to from mobile telecommunication devices, such as mobile telephones, and converts the voice data into data packets, preferably in an IP Protocol. In transmission, the packets with voice data are then sent to the communication server(s) hosting the communication channel for the mobile device and are carried with non-voice data packets in a single communication channel to other mobile communication devices. In receipt, the voice data packets can be returned to analog voice data at the converter server, or alternately, the mobile device will handle the separation and conversion of the voice data from data packets received.

### BACKGROUND OF THE INVENTION

1. Field of the Invention

The present invention relates to voice and data communication between computer devices across wireless telecommunication infrastructure. More particularly, the invention relates to transmission of both voice and data packets to a wireless telecommunication device over a single established data communication channel.

2. Description of the Related Art

The first cellular networks were introduced in the early 1980s using analog radio transmission technologies such as AMPS (Advanced Mobile Phone System). Within a few years, cellular systems began to hit a capacity ceiling as millions of new subscribers signed up for service requiring increased airtime. Dropped calls and network busy signals became common in many areas. To accommodate more traffic within a limited amount of radio spectrum, the industry developed a new set of digital wireless technologies called TDMA (Time Division Multiple Access), GSM (Global System for Mobile), and CDMA (Code Division Multiple Access). TDMA and GSM use a time-sharing protocol to provide three to four times more capacity than analog systems. CDMA, however, is based upon a multiple access technique using orthogonal codes to keep information channels separate from each other.

CDMA specifically uses a family of orthogonal codes known as Walsh functions. When digitized speech information is combined with a Walsh encoding and then modulated onto a carrier signal, other coded speech signals with different Walsh codes can be carried on the same signal and the speech information will not interfere with each other because of the orthogonal properties of the Walsh codes. The orthogonal spreading allows only the receiver with the same code to recover that encoded signal and other communication signals using separate Walsh codes appear like noise to the receiver. For example, using the common Walsh coding with 64-bits, each communication channel is assigned a unique Walsh code from 0-63. Thus, 64 separate Walsh code pairs (are unique within channels of same user, as well across different users in same receiving area.

There are however, a limited number of Walsh codes available for data channels in a given frequency spectrum. And a pair of Walsh codes is necessary for communicating with a mobile device, one for forward communication (sending voice to the telephone) and one for reverse communication (receiving voice from the telephone). Consequently, in applications with a narrow frequency of broadcast spectrum with a finite number of bits to allocate for Walsh encoding, there are a limited number of codes available for forward and reverse communication channels with mobile devices.

A modern standard of CDMA technology, CDMA2000, supports both voice and data services over a standard CDMA communication channel. As specified in CDMA 2000, if a wireless subscriber is engaged in an active packet-data session, the subscriber is unable to simultaneously support a traditional voice call without relying on advanced features of IS-2000 which require infrastructure elements to maintain and support states for more than a single dedicated Walsh channel pair per mobile device simultaneously. The IS-2000 standard does not allow for a traditional voice call (one service) to be delivered and supported by the mobile device where the mobile device is actively engaged in packet-data activity without requiring an additional communication channel or dedicating the fundamental channel (FCH) for voice data and the dedicated control channel (DCCH) for packet-data.

The IS-2000 standard addresses this problem by defining a voice packet 2 (VP2) mode, wherein the infrastructure allocates Walsh codes for the forward (F-FCH) and reverse (R-FCH) fundamental channels and dedicates these channels to support the voice calls, and then simultaneously allocates Walsh codes for the duplex packet-data. This solution however still requires the problematic allocation of two Walsh code pairs.

Accordingly, it would be advantageous to provide a system and method for allowing simultaneous voice and data communication across a single Walsh pair communication channel. Such system and method should allow the transmission of both voice and data packets to mobile communication devices with minimal hardware overhead required. Further, such system and method should be able to open up further communication channels to the mobile device where each additional communication channel can handle simultaneous voice and data transmission, should additional bandwidth to the mobile device be required. It is thus to the provision of such a system and method of simultaneous transmission of both voice and data packets to a wireless telecommunication device over a single data communication channel that the present invention is primarily directed.

### SUMMARY OF THE INVENTION

The present invention is a system and method that allows one pair of Walsh codes to support both voice and data communication simultaneously by converting an incoming voice call received while a wireless subscriber is engaged in an active packet-data call to a voice over IP-based call, or other suitable format, delivering the incoming call signal to the mobile device using the existing Forward/Reverse DCCH connection. The active data-packet service remains, and any user packet-data traffic continues to be transmitted interleaved with the packets carrying voice data. The further allocation of Walsh code pairs and other channels is permissible to achieve higher bandwidth with the mobile device, but is not necessary for the simultaneous voice and data communication.

In one embodiment, the system for enabling simultaneous voice and data communication over a single communication channel in a wireless telecommunication network is comprised of a first communication server that provides one or more communication channels to one or more mobile communication devices, at least one mobile communication device that selectively communications at least data having a first protocol over the one or more communication channels provided by the first communication server, at least one data server that communicates data with the at least one mobile communication device, and a converter server that converts voice data having a first protocol to data having a second protocol transmittable over the one or more communication channels. The converter server sends the converted voice data having a second protocol to the first communication server for transmission across at least one communication channel to the at least one mobile communication device. The converter server can also receive converted voice data having a second protocol, convert it to regular voice data having a first protocol, and transmit.

In one embodiment, the method for enabling simultaneous voice and data communication over a single communication channel in a wireless telecommunication network includes the steps of providing one or more communication channels to one or more mobile communication devices through a first communication server; selectively communicating at least data having a first protocol over the one or more communication channels provided by the first communication server from a mobile communication device to at least one data server; converting voice data to data having a second protocol transmittable over the one or more communication channels at a converter server; and sending the converted voice data having a second protocol from the converter server to the first communication server for transmission across at least one communication channel to the at least one mobile communication device.

In one embodiment, the invention includes a converter server that converts voice data to data transmittable over one or more communication channels on a wireless telecommunication network between one or more data servers and one or more mobile communication devices, the one or more communication channels provided to the one or more mobile communication devices via a first communication server whereby the mobile communication device selectively communicates at least data over the one or more communication channels, and the converter server sending the converted voice data to the first communication server for transmission across at least one communication channel to the at least one mobile communication device.

In one embodiment, the invention includes a method of enabling simultaneous voice and data communication over a single communication channel in a wireless telecommunication network through the use of the converter server. The method includes the steps of receiving voice data at the converter server where the voice data originated from at least a first mobile telecommunication device that selectively communicates across a wireless telecommunication network through one or more communication channels provided to the at least first mobile communication device via one or more communication servers, then converting the voice data to voice packet data having a transmission protocol where the voice data packets are transmittable over one or more communication channels to one or more second mobile communication devices with other data packets having the transmission protocol. The method then includes the step of sending the voice data packets to the one or more communication servers for transmission across one or more communication channels to one or more second mobile communication devices.

It is therefore an object of the system and method to allow simultaneous voice and data communication across a single communication channel that uses a pair of Walsh codes. The system and method further allows the transmission of both voice and data packets interleaved in the data stream to and from mobile communication devices with minimal hardware required as the translation of the voice data into packet data preferably occurs at a converter server network-side. The system and method can also provide further communication channels to the mobile device should bandwidth be required where each additional communication channel can handle simultaneous voice and data transmission.

Other objects, advantages, and features of the present invention will become apparent after review of the hereinafter set forth Brief Description of the Drawings, Detailed Description of the Invention, and the Claims.

### BRIEF DESCRIPTION OF THE DRAWINGS

FIG. 1 is a representative diagram of a wireless network with a mobile telecommunication device communicating with a group of other mobile telecommunication devices across the wireless network.

FIG. 2 is a representative diagram of one embodiment of a wireless network in a common CDMA cellular telecommunication configuration, having one or more IP Packet converter servers facilitate communication between the wireless telecommunication devices that use voice analog and/or IP packet data communications.

FIG. 3 is a block diagram illustrating the computer platform of the wireless telecommunication device with a resident voice packet handling device.

FIG. 4 is a flowchart of one embodiment of the process to handle and convert voice data to and from data packets at a converter server in the wireless network.

FIG. 5A is a flowchart of one embodiment of the process executing on the embodiment of the mobile telecommunication device in FIG. 3 to handle incoming data packet traffic.

FIG. 5B is a flowchart of one embodiment of the process executing on the embodiment of the mobile telecommunication device in FIG. 3 to convert voice data into voice packet data for transmission.

### DETAILED DESCRIPTION OF THE INVENTION

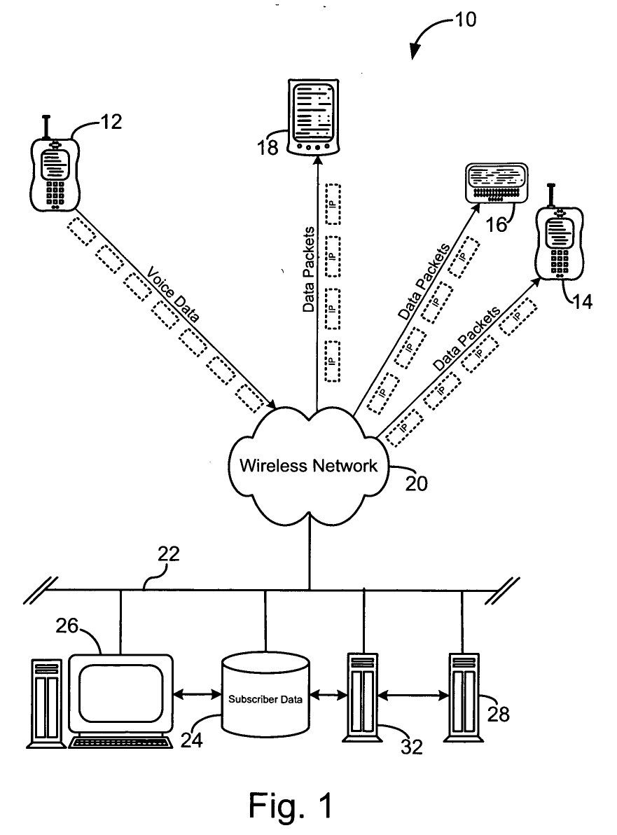

With reference to the figures in which like numerals represent like elements throughout, FIG. 1 illustrates a wireless telecommunication system 10 for that allows communication channels between one or more wireless telecommunication devices, such as the wireless telephones 12,14 smart pager 16, and personal digital assistant (PDA) 18, with other wireless telecommunication devices across a wireless network 20. The system 10 particularly enables simultaneous voice and data communication over a single communication channel to a wireless n network 20. A first communication server 26 provides one or more communication channels to one or more mobile communication devices, such as devices 12,14,16,18, and at least one mobile communication device, such as cellular telephone 12 selectively communications at least data over one or more communication channels provided by the first communication server 26. At least one data server 28 communicates data with the mobile communication devices 12,14,16,18, and a converter server 32 converts voice data to data transmittable over one or more communication channels, and the converter server 32 sending the converted voice data to the first communication server 26 for transmission across at least one communication channel to the at least one mobile communication device, such as cellular telephone 14.

As shown in FIG. 1, cellular telephone 12 sends voice data, in typically in frames or packets, to the wireless network 20, typically to the first communication server 26, which is present on a server-side LAN 22 across the wireless network. The first communication server 26 relays the data to the converter server 32. In other embodiments, further described herein, other computer devices can be resident on the server-side LAN 22 or be accessible across the wireless network 20 to the wireless devices. The first communication server 26 can have an attached or accessible database, such as subscriber data 24 that stores the identification data of subscribers for the wireless devices whereby the communications for various subscribers can be known by the system 10, i.e. which mobile devices 12,14,16,18 can communication in which format. It should be appreciated that the number of computer components resident on server-side LAN 22, or across the wireless network 20, or Internet generally, are not limited.

In one embodiment, the mobile device 12,14,16,18 can receive both voice data and data communication over the wireless telecommunication network 20. And as necessary for bandwidth, the system 10 can establish a second communication channel between the first communication server 26 and a mobile device 12,14,16,18, where the second communication can also support both voice and data packets interleaved. Further, as shown herein the converter server 32 preferably converts the voice data into internet protocol (IP) data packets, but can alternately use any data frame format where voice data and other computer readable data can be simultaneously encoded. Thus, in the embodiment of FIG. 1, the converter server 32 receives both voice data from mobile devices, such as cellular telephone 12, and converts the received voice data into voice packet data in an IP protocol, and can do the opposite transformation to return IP packet data to voice analog data, or voice data in the appropriate frames, and send the voice data to the communication server 26. And if the mobile communication device 12,14,16,18 is so embodied, the device can convert the transmitted data packets into voice data, and in such embodiment, the communication server 26 need only relay IP packet data to the mobile device 12,14,16,18 and the converter server 32 is unnecessary as the conversion to voice data occurs at the mobile device 12,14,16,18.

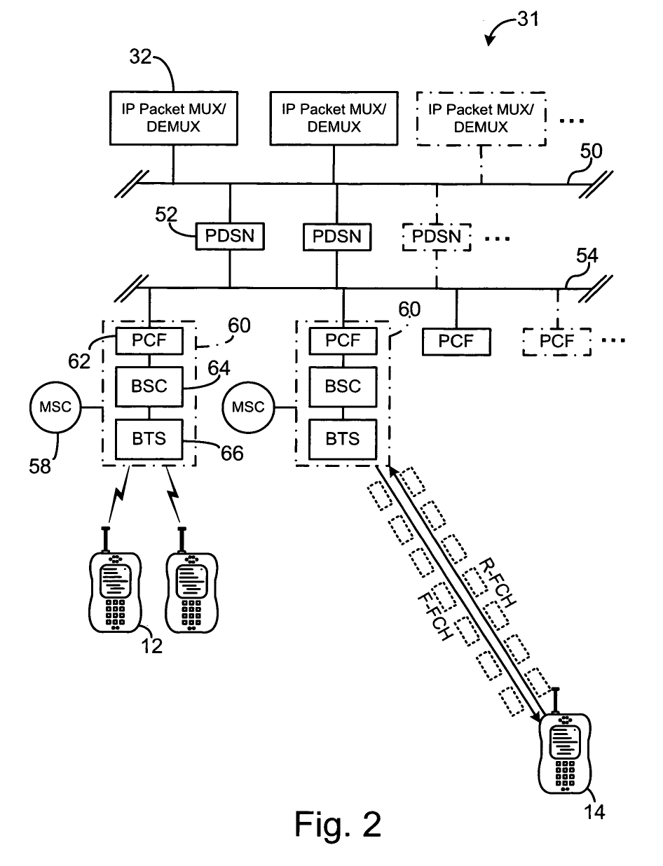

FIG. 2 is a representative diagram of one embodiment of a wireless network in a common CDMA cellular telecommunication configuration 31, having an array of converter servers 32 to provide the ability for mobile devices 12,14,16,18 to communicate to each other using a data packet protocol, such as an IP protocol, for unified voice and data transmission over a single Walsh pair channel. The wireless network is merely exemplary and can include any system whereby remote modules communicate over-the-air between and among each other and/or between and among components of a wireless network 20, including, without limitation, wireless network carriers and/or servers. A series of converter servers 32 are connected to a group communication server LAN 50. Each converter server 32 is shown here as an IP protocol multiplex (MUX)/demultiplex (DEMUX) such that the converter server 32 can convert the voice data to and from IP packet data for the various mobile devices. Wireless telephones can request packet data sessions from the converter server(s) 32 using a data service option.

The converter server(s) 32 are connected to a wireless service provider's packet data service node (PDSN) such as PSDN 52, shown here resident on a carrier network 54. Each PSDN 52 can interface with a base station controller 64 of a base station 60 through a packet control function (PCF) 62. The PCF 62 is typically located in the base station 60. The carrier network 54 controls messages (generally in the form of data packets) sent to a messaging service controller (“MSC”) 58. The carrier network 30 communicates with the MSC 32 by a network, the Internet and/or POTS (“plain ordinary telephone system”). Typically, the network or Internet connection between the carrier network 54 and the MSC 58 transfers data, and the POTS transfers voice information. The MSC 58 can be connected to one or more base stations 60. In a similar manner to the carrier network, the MSC 58 is typically connected to the branch-to-source (BTS) 66 by both the network and/or Internet for data transfer and POTS for voice information. The BTS 66 ultimately broadcasts and receives messages wirelessly to and from the wireless devices, such as mobile devices 12,14,16,18, by short messaging service (“SMS”), or other over-the-air methods known in the art.

Cellular telephones and telecommunication devices, such as wireless telephone 14, are being manufactured with increased computing capabilities and are becoming tantamount to personal computers and hand-held PDAs, and accordingly communicate as much computer data as voice data. These “smart” cellular telephones allow software developers to create software applications that are downloadable and executable on the processor of the wireless device. The wireless device, such as cellular telephone 14, can download and send many types of applications, such as web pages, applets, MIDlets, games and stock monitors, or simply data such as news and sports-related data. In direct communications, the mobile device, such as cellular telephone 12, will transmit its voice and/or computer data to the wireless network, an the devices of the wireless network will occur through, or at the control of, the group communication server 32. All data packets of the devices do not necessarily have to travel through the group communication server 32 itself, but the server 32 must be able to ultimately control the communication because it will typically be the only server-side 30 component that is aware of and/or can retrieve the identity of the members of the set 12, or direct the identity of the members of the set 12 to another computer device, such as mapping server 36.

As further shown in FIG. 2, the cellular telephone 14 uses a communication channel with the base station 60 and establishes a forward fundamental channel (F-FCH) and a reverse fundamental channel (R-FCH), each fundamental channel using a Walsh code for communication and hence the establishing of the dedicated channel requiring a pair of Walsh codes. For voice data, the data is typical encapsulated in data frames and handled by the PCF 60. In this embodiment, the converter server 32 will receive the stream of standard voice packets from the PDSN 52 and convert the voice packets into data packets, preferably in IP Protocol, such as a common Voice-over-IP Protocol as known in the art.

In telecommunications, a “frame” is data transmitted between network points as unit with addressing and the requisite protocol control information. The frame commonly is transmitted serially and contains a header field and a trailer field that border the data. (It should be noted that some control frames contain no data) A basic representation of a frame is:

| | |
|---|---|
| HEADER | TRAILER |

| | | | | |
|---|---|---|---|---|
| START | Address | DATA | FRAME | END |
| FLAG(01) | | | CHECK | FLAG(10) |

In the figure above, the start flag and address field constitute the header and the frame check sequence and end flag field constitute the trailer. The information or data in the frame may contain another encapsulated frame that is used in a higher-level or different protocol. Actually, in many instances, a frame constructed for data relay typically carries data that has been framed by an earlier protocol program. Thus, voice packets used in the CDMA communication protocol will typically be in a frame or packet of a first transmission protocol, and the converter server 32 can either encapsulate the voice packet frame of the first transmission protocol within an IP protocol frame (second transmission protocol) for relay, or can completely convert the voice data into IP protocol data. If so embodied, the converter server 32 likewise can remove, extract, or convert the voice data from the IP protocol frame and relay the voice data, typically in common voice packet relay form, to the communication server 26 for relay to the mobile device 12,14,16,18.

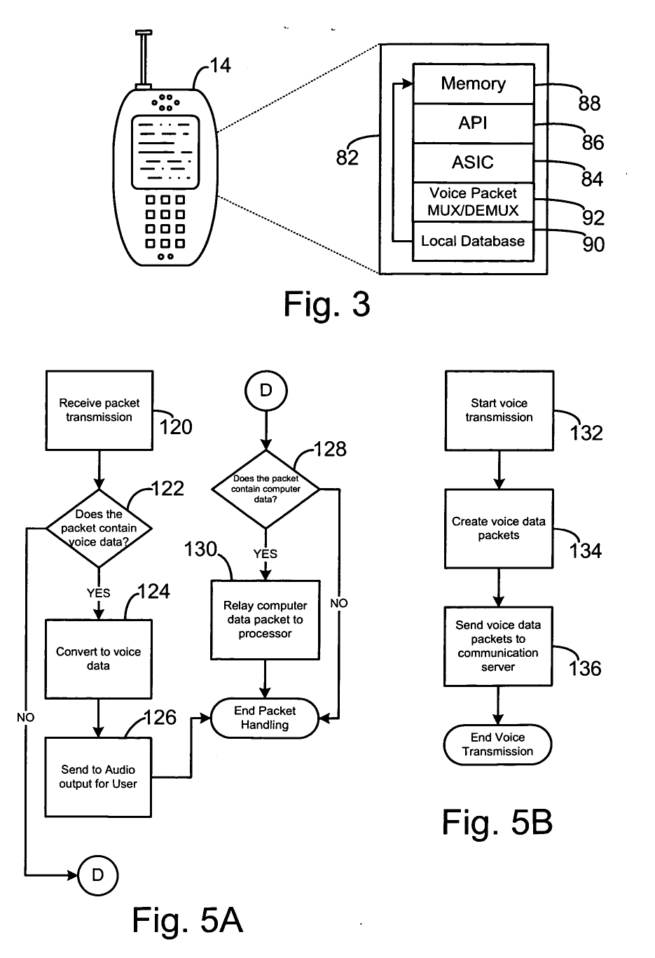

FIG. 3 is a block diagram illustrating the computer platform 82 of the wireless device (cellular telephone 14) with a resident IP Voice Packet MUX/DEMUX device 92. The wireless device 14 includes a computer platform 82 that can handle voice and data packets, and receive and execute software applications transmitted across the wireless network 20. The computer platform 80 includes, among other components, an application-specific integrated circuit (“ASIC”) 84, or other processor, microprocessor, logic circuit, programmable gate array, or other data processing device. The ASIC 84 is installed at the time of manufacture of the wireless device and is not normally upgradeable. The ASIC 84 or other processor executes an application programming interface (“API”) layer 86, which includes the resident application environment, and can include the operating system loaded on the ASIC 84. The resident application environment interfaces with any resident programs in the memory 88 of the wireless device. An example of a resident application environment is the “binary runtime environment for wireless” (BREW) software developed by Qualcomm® for wireless device platforms.

As shown here, the wireless device can be a cellular telephone 14, with a graphics display, but can also be any wireless device with a computer platform as known in the art, such as a personal digital assistant (PDA), a pager with a graphics display, or even a separate computer platform that has a wireless communication portal, and may otherwise have a wired connection to a network or the Internet. Further, the memory 88 can be comprised of read-only or random-access memory (RAM and ROM), EPROM, EEPROM, flash cards, or any memory common to computer platforms. The computer platform 82 can also include a local database 90 for storage of software applications not actively used in memory 88. The local database 90 is typically comprised of one or more flash memory cells, but can be any secondary or tertiary storage device as known in the art, such as magnetic media, EPROM, EEPROM, optical media, tape, or soft or hard disk.

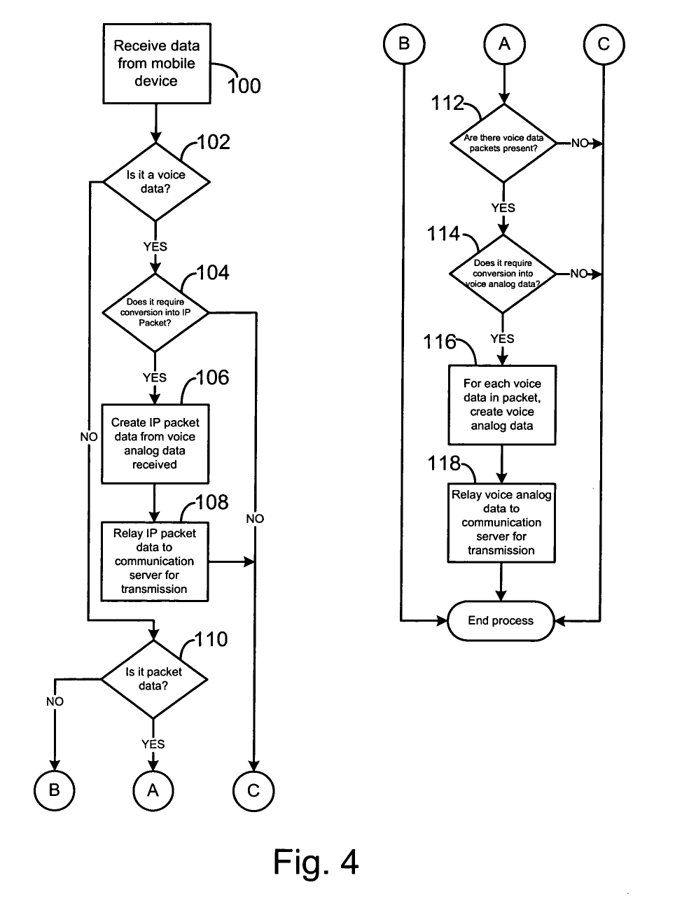

FIG. 4 is a flowchart of one embodiment of the process executing at the converter server 32 to receive and convert data frames from mobile devices 12,14,16,18. The converter server 32 receives data from the mobile 12,14,16,18, as shown at step 100. The process typically will start automatically as a mobile device user has initiated communication with another device across the wireless network 20. After the data has been received, typically in a first protocol packet or frame form (either voice or data), the converter server 32 makes a determination as to whether the data is a voice data, as shown at decision 102. If the data is not a voice data at decision 102, then the process forwards to decision 110. Otherwise, if the data is voice data at decision 102, a determination is then made as to whether the voice data requires conversion into an IP data packet or frame, as shown at decision 104.

If the voice data does not require conversion at decision 104, the process then terminates. An example of the determination would be if the receiving mobile device 12,14,16,18 or other device relaying communication data to the receiving device cannot handle IP packet data. Otherwise, if the voice data requires conversion at decision 104, then the IP packet is created from the voice analog data received as shown at step 108, and then the process for the handling of that particular voice data terminates.

In this embodiment of the process, the converter server can also convert IP packet data into voice analog data (or traditional voice packets of the original protocol) before relay to the receiving mobile device 12,14,16,18. If the incoming data was not a voice data at decision 102, a determination is then made as to whether the data is packet data, i.e. computer or other informational data, as shown at decision 110. If the incoming data is not packet data at decision 110, then the process terminates. Otherwise, if the incoming data is packet data at decision 110, then a determination is made as to whether voice data may be present in the packet, e.g. is there voice data encapsulated in the packet, as shown at decision 112. If there is no voice data present in the data packet at decision 112, then the process terminates. Otherwise, if there is voice data present in the data packet, a determination is then made as to whether the voice data will require conversion to voice analog data for relay, as shown at decision 114. In other words, the converter server 32 will determine if the intended receiving mobile device 12,14,16,18 can handle the IP packet as is and get the voice data from it. Consequently, if the voice data does not need conversion at decision 114, then the process termination and the data packet is allowed to pass through to the receiving mobile device 12,14,16,18. Otherwise, if the voice data does require conversion at decision 114, then for each voice data in the packet, the converter server 32 creates voice analog data or other traditional voice packet, as shown at step 116, and then the voice data is relayed to the communication server 26 for ultimate reception at the mobile device 12,14,16,18, as shown at step 118. Then the process terminates.

FIG. 5A is a flowchart of one embodiment of the process executing on the embodiment of the mobile telecommunication device 14 in FIG. 3 to handle incoming data packet traffic. The mobile device 14 receives an incoming packet transmission, as shown at step 120 and then a determination is made as to whether the incoming packet contains voice data, as shown at decision 122. In this example, the mobile device 14 will review the IP data packet to see if it contains computer data or voice data. If the incoming packet is determined to not contain voice data at decision 122, then a determination is made as to whether the packet contains computer data at decision 128. Otherwise, if the incoming packet does contain voice data at decision 122, the data packet is converted to vice data, as shown at step 124, through the use of the resident voice packet MUX/DEMUX 92. The audio output of the converted packet is then sent to the user and the packet handling process terminates.

Otherwise, if the packet did not contain voice data at decision 122, a determination is then made as to whether the packet contains computer data at decision 128. If the packet does not contain computer data at decision 128, then the packet handling process terminates. This would occur if the packet was a control packet or other non-communicative packet. If the packet does contain computer data at decision 128, then the computer data is relayed to the processor, such as ASIC 84, and then the packet handling process terminates.

FIG. 5B is a flowchart of one embodiment of the process executing on the embodiment of the mobile telecommunication device in FIG. 3 to convert voice data from the user into voice packet data for transmission. Voice transmission starts, as shown at step 132, and then the mobile device creates IP voice data packets from the resident voice packet MUX/DEMUX 92, as shown at step 134. The voice data packets are then sent to the communication server 26 that is bridging a communication channel with the mobile device 14, as shown at step 136 and the voice transmission process terminates.

It can thus be seen that the system 10 therefore provides a method for enabling simultaneous voice and data communication over a single communication channel in a wireless telecommunication network 20 including the steps of providing one or more communication channels to one or more mobile communication devices 12,14,16,18 through a first communication server 26, then selectively communicating at least data over the one or more communication channels provided by the first communication server 26 from a mobile communication device 12,14,16,18 to at least one data server 28 (PSDN 52), then converting voice data having a first protocol, such as CDMA voice frames, to data of a second protocol, such as IP packet data, transmittable over the one or more communication channels at a converter server 32, and then sending the converted voice data from the converter server 32 to the first communication server 26 for transmission across at least one communication channel to the at least one mobile communication device, such as cellular telephone 14. The method can further include the steps of receiving both voice data and data communication over the wireless telecommunication network 20, and selectively establishing a second communication channel between the first communication server 26 and the at least one mobile device 12,14,16,18, where the second communication channel provides additional data communication with the at least one mobile device, such as cellular telephone 14. The method can also further include the steps of receiving data in a second protocol, such as IP packet data, at the converter server 32 from the at least one mobile device and converting the received data into voice data of another protocol, such as CDMA voice frames, as shown in the embodiment of FIG. 4.

In one embodiment, the converter server 32 performs a method of enabling simultaneous voice and data communication over a single communication channel in a wireless telecommunication network 20 through the steps of receiving voice data at the converter server 32 (step 100), the voice data originating from at least a first mobile telecommunication device, such as cellular telephone 12, that selectively communicates across the wireless telecommunication network 20 through one or more communication channels provided to the at least first mobile communication device via communication server(s) 26. Then the method includes the steps of converting the voice data to voice packet data having a transmission protocol (preferably an IP Protocol), where the voice data packets are transmittable over the one or more communication channels to one or more second mobile communication devices, such as mobile device 14,16,18 with other data packets having the transmission protocol, and then sending the voice data packets to the communication server(s) 26 for transmission across one or more communication channels to one or more second mobile communication devices 14,16,18.

The method of the converter server 32 can further include the step of sending both voice data packets and data packets from the converter server 32 over the wireless telecommunication network 20. The method can also include the steps of receiving data packets from the at least first mobile device 12, and converting the received data packets into voice data, as shown in FIG. 4. The step of sending the voice data packets can be sending the voice data packets directly to the communication server(s) 26.

The method accordingly can be implemented by the execution of a program held computer readable medium, such as the memory 88 of the computer platform 82, or the converter server 32. The instructions can reside in various types of signal-bearing or data storage primary, secondary, or tertiary media. The media may comprise, for example, RAM (not shown) accessible by, or residing within, the wireless device. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the foregoing disclosure shows illustrative embodiments of the invention, it should be noted that various changes and modifications could be made herein without departing from the scope of the invention as defined by the appended claims. Furthermore, although elements of the invention may be described or claimed in the singular, the plural is contemplated unless limitation to the singular is explicitly stated.

What is claimed is:

1. A system for enabling simultaneous voice and data communication over a single communication channel in a wireless telecommunication network, comprising:
a first communication server that provides one or more communication channels to one or more mobile communication devices;
at least one mobile communication device that selectively communicates at least data having a first protocol over the one or more communication channels provided by the first communication server;
at least one data server that communicates data with the at least one mobile communication device; and
a converter server that converts voice data having a first protocol to data having a second protocol transmittable over the one or more communication channels, and the converter server sending the data having the second protocol to the first communication server for transmission across at least one communication channel to the at least one mobile communication device.

2. The system of claim 1, wherein the mobile device receives both voice data and data communication over the wireless telecommunication network.

3. The system of claim 1, wherein a second communication channel is selectively established between the first communication server and the at least one mobile device, the second communication channel providing additional data communication with the at least one mobile device.

4. The system of claim 1, wherein the converter server converts the voice data into IP protocol data packets.

5. The system of claim 1, wherein the converter server further receives data having a second protocol from the at least one mobile device and converts the received data into voice data having a first protocol.

6. The system of claim 4, wherein the at least one mobile communication device converts the transmitted data packets into voice data.

7. A system for enabling simultaneous voice and data communication over a single communication channel in a wireless telecommunication network, comprising:
a first communication means for providing one or more wireless communication channels;
a mobile communication means for selectively communicating at least data over the one or more communication channels provided by the first communication means;
a data serving means that communicates data with the mobile communication means; and
a converter means for converting voice data to data transmittable over the one or more communication channels, and the converter means further sending the converted voice data to the first communication means for transmission across at least one communication channel to the mobile communication means.

8. A method for enabling simultaneous voice and data communication over a single communication channel in a wireless telecommunication network, comprising the steps of:
providing one or more communication channels to one or more mobile communication devices through a first communication server;
selectively communicating at least data over the one or more communication channels provided by the first communication server from a mobile communication device to at least one data server;
converting at a converter server voice data having a first protocol to data having a second protocol transmittable over the one or more communication channels; and
sending the data having a second protocol from the converter server to the first communication server for transmission across at least one communication channel to the at least one mobile communication device.

9. The method of claim 8, further comprising the step of receiving both voice data and data communication over the wireless telecommunication network.

10. The method of claim 8, further comprising the step of selectively establishing a second communication channel between the first communication server and the at least one mobile device, the second communication channel providing additional data communication with the at least one mobile device.

11. The method of claim 8, wherein the step of converting the voice data is converting the voice data into IP protocol data packets.

12. The method of claim 8, further comprising the steps of:
receiving data having a second protocol at the converter server further from the at least one mobile device; and
converting the received data having a second protocol into voice data having a first protocol.

13. The method of claim 12, wherein the step of converting the received data having a second protocol from the at least one mobile communication device is converting the transmitted data packets into voice data.

14. A method for enabling simultaneous voice and data communication over a single communication channel in a wireless telecommunication network, comprising:
a step for providing one or more communication channels to one or more mobile communication devices through a first communication server;
a step for selectively communicating at least data over the one or more communication channels provided by the first communication server from a mobile communication device to at least one data server;
a step for converting voice data to data transmittable over the one or more communication channels at a converter server; and
a step for sending the converted voice data from the converter server to the first communication server for transmission across at least one communication channel to the at least one mobile communication device.

15. A converter server that converts voice data to data transmittable over one or more communication channels on a wireless telecommunication network between one or more data servers and one or more mobile communication devices, the one or more communication channels provided to the one or more mobile communication devices via a first communication server whereby the mobile communication device selectively communicates at least data over the one or more communication channels, and the converter server sending the converted voice data to the first communication server for transmission across at least one communication channel to the at least one mobile communication device.

16. The server of claim 15, wherein the server transmits both voice data and data communication over the wireless telecommunication network.

17. The server of claim 15, wherein the server converts the voice data into IP protocol data packets.

18. The server of claim 15, wherein the converter server further receives data from at least one mobile device and converts the received data into voice data.

19. The server of claim 15, wherein the server selectively relays data packets without conversion.

20. A method of enabling simultaneous voice and data communication over a single communication channel in a wireless telecommunication network, comprising the steps of:
receiving voice data at a converter server, the voice data originating from at least a first mobile telecommunication device that selectively communicates across a wireless telecommunication network through one or more communication channels provided to the at least first mobile communication device via one or more communication servers;
converting the voice data to voice packet data having a transmission protocol, the voice data packets transmittable over one or more communication channels to one or more second mobile communication devices with other data packets having the transmission protocol; and
sending the voice data packets to the one or more communication servers for transmission across one or more communication channels to one or more second mobile communication devices.

21. The method of claim 20, further comprising the step of sending both voice data packets and data packets from the converter server over the wireless telecommunication network.

22. The method of claim 20, wherein the step of converting the voice data is converting the voice data into IP protocol data packets.

23. The method of claim 20, further comprising the steps of:
receiving data packets from the at least first mobile device; and
converting the received data packets into voice data.

24. The method of claim 20, wherein the step of sending the voice data packets is sending the voice data packets directly to the one or more communication servers.

25. A computer program that, when executed by a computer server, causes the server to enabling simultaneous voice and data communication over a single communication channel in a wireless telecommunication network, through performing the steps of:
receiving voice data at the converter server, the voice data originating from at least a first mobile telecommunication device that selectively communicates across a wireless telecommunication network through one or more communication channels provided to the at least first mobile communication device via one or more communication servers;
converting the voice data to voice packet data having a transmission protocol, the voice data packets transmittable over one or more communication channels to one or more second mobile communication device with other data packets having the transmission protocol; and
sending the voice data packets to the one or more communication servers for transmission across one or more communication channels to one or more second mobile communication devices.

26. The program of claim 25, further causing the server to perform the step of sending both voice data packets and data packets from the converter server over the wireless telecommunication network.

27. The program of claim 25, wherein the program causes the step of converting the voice data to be converting the voice data into IP protocol data packets.

28. The program of claim 25, further causing the server to perform the steps of:
receiving data packets from the at least first mobile device; and
converting the received data packets into voice data.

29. The program of claim 25, wherein the program causes the step of sending the voice data packets to be sending the voice data packets directly to the one or more communication servers.
